(19) United States
(12) Patent Application Publication
(10) Pub. No.: US 2005/0186489 A1
(43) Pub. Date: Aug. 25, 2005

(54) Color filter materials, color filters, manufacturing method and image sensor

(76) Inventors: Tomoko Komatsu, Kyotanabe-shi (JP); Mitsuru Harada, Katano-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/060,506

(22) Filed: Feb. 18, 2005

(30) Foreign Application Priority Data
Feb. 19, 2004 (JP) 2004-042589

(51) Int. Cl. G02B 5/20

(52) U.S. Cl. 430/7; 257/440

(57) ABSTRACT

Color filter materials 5 to 7 include a dye which has a light sensing function. The curing reaction may be one of radical polymerization, cationic polymerization, and anionic polymerization. The manufacturing method of color filters 15 to 17 includes processes: coat-forming, on the base, color filter material layers 5 to 7 including a dye which has a light sensing function; exposing a predetermined area on the color filter material layers 5 to 7; and removing color filter material layers 5 to 7 outside the predetermined area by a developer and forming color filters 15 to 17 on a predetermined area.

### BACKGROUND OF THE INVENTION

(1) Field of the Invention

The present invention relates to color filter materials, color filters, a manufacturing method and an image sensor.

(2) Description of the Related Art

As a method for manufacturing a color filter to be mounted on an image sensor, a dyeing method, an electrodepositing method, a printing method and a dye dispersion method are used at present.

The dyeing method that is one of the above-mentioned manufacturing methods is for manufacturing color filters by dyeing a substrate made of a natural resin such as gelatin, glue, casein and the like or a synthetic resin such as amine-modified polyvinyl alcohol using an acid dye and the like. This method has the advantages of (i) excellent spectral characteristics and (ii) color purity, but it also has the disadvantages that (i) color shading is likely to occur because it is difficult to control a dyeing process and adhere a dye evenly in the manufacturing process and (ii) the dyeing processing is made complicated because an additional process of protection against dyeing is needed in the dyeing process.

In the technique disclosed in Document 1: the Japanese Laid-Open Patent application No. 2002-323762 publication, a negative type photosensitive composition is used as a color film material that is obtained by mixing and dissolving a photosensitive resin composition in which a light polymerization initiator including O-acyloxim radicals are used and a dye in order to manufacture a color filter that has an excellent resolution, shape, heat resistance and spectral characteristic.

This negative type color photosensitive composition is not susceptible to oxygen inhibition when a light polymerization initiator including O-acyloxime starts polymerization, which makes it possible to form a color filter having few resin embossing impressions and an excellent resolution and little dye bleeding in forming a color filter mounted on, for example, a liquid crystal display device and a charge-coupled device.

As a preparation example disclosed in Document 1, a negative type photosensitive composition is used. The negative type photosensitive composition is a mixture of: 0.17 g of polyvinyl pyrrolidone (made by BASF Co., Ltd) as a binder polymer; 0.17 g of Kayarad DPHA (made by Nippon Kayaku Co., Ltd) as a light polymerization monomer; 0.08 g of 1-(4-phenyl sulfanylphenyl) butane-1,2-dione-2-oxime-o-benzoate as a light polymerization initiator; 0.15 g of Neozapon blue 807 (made by BASF Co., Ltd) as a dye; and 3 g of ethyl lactate.

Also, an organic solvent should dissolve components of the negative type photosensitive composition. Such components are a binder polymer, a light polymerization monomer or an oligomer, a light polymerization initiator and a dye. Available organic solvents are, for example, (i) benzenes such as benzene, toluene and xylene, (ii) cellosolves such as methyl cellosolve, ethyl cellosolve and buthyl cellosolve, (iii) cellosolve acetic ethers such as methyl cellosolve acetate, ethyl cellosolve acetate and buthyl cellosolve acetate, (iv) propylene glycol monoalkyl ether acetates such as propylene glycol monomethyl ether acetate, propylene glycol monoethyl ether acetate and propylene glycol monobuthyl ether acetate, (v) propionates such as methyl 3-methoxypropionate, ethyl 3-methoxypropionate and buthyl 3-methoxypropionate, (vi) lactates such as methyl lactate, ethyl lactate and buthyl lactate, (vii) diethylene glycols such as diethylene glycol monomethyl ether and diethylene glycol monoethyl ether, (viii) acetates such as methyl acetate, ethyl acetate and buthyl acetate, (ix) ethers such as dimethyl ether, diethyl ether, tetrahydrofuran and dioxane, (x) ketones such as acetone, methyl ethyl ketone, methyl buthyl ketone, and cyclohexanone.

However, as will be described later, there is a problem in a conventional technique: It is difficult to make color filters thinner.

In the conventional technique, dyes are dissolved in such color filters. More specifically, dyes are a part of color filter materials and, the rest of color filter materials include a resin as a binder, a solvent, a thermosetting material, a light curing initiator, a filler and an additive. Therefore, in order to make such color filters thinner, there is a need to increase the ratio of dyes in the color filter materials and decrease the ratio of resins. However, increasing the ratio of dyes exceeding a certain degree causing a phenomenon that color filters do not sufficiently cure even in the case of increasing the amount of a thermosetting material or a light curing initiator. This makes it extremely difficult, at present, to manufacture a color filter using color filter materials where the weight ratio of dyes is increased up to approximately 40% or more. Therefore, at present, the color filters to be mounted on image sensors cannot be made thinner than approximately 1 μm or below. This is an obstacle in making image sensors thinner, refining the image sensors and improving the sensitivity of image sensors.

Especially in the case of a thin filter for green, it cannot be made using a single layer and may be made in a form of a laminated structure of two filters being a yellow filter and a cyan filter. The reason is the conventional technique includes the following problem: there is a need to increase the amount of dye in order to obtain a sufficient spectral characteristic; however, too much amount of dye prevents curing. This results in making a thick laminated structure of two filters.

### SUMMARY OF THE INVENTION

The present invention is conceived considering the above-mentioned circumstances. An object of the present invention is to provide a color filter material for making color filters thinner, a manufacturing method of such color filters, and a thinner image sensor having a high sensitivity on which such color filters are mounted.

In order to achieve the above-mentioned object, the color filter materials concerning the present invention include a dye which has a light sensing function.

Here, in a first aspect of the present invention, in the color filter material, the dye may cure upon sensing light by one of radical polymerization, cationic polymerization and anionic polymerization.

Here, in a second aspect of the present invention, the dye may include a compound having acryloyl radicals and radically polymerize upon sensing light.

Here, in the second aspect of the present invention, the dye may include a compound having methacryloyl radicals and radically polymerize upon sensing light.

Here, in the second aspect of the present invention, the dye may include at least one of a compound having maleimide radicals and an enthiol compound, and radically polymerize upon sensing light.

Here, in the second aspect of the present invention, the dye may include at least one of an epoxy compound, an oxetane compound, a vinyl ether compound and a propenyl etherate, and cationically polymerize upon sensing light.

Here, in the second aspect of the present invention, the dye may include an epoxy compound and anionically polymerize upon sensing light.

Here, in the first aspect of the present invention, the dye may further have a heat curing property.

Also, the color filters concerning the present invention includes a color filter material having a dye which has a light sensing function.

Also, the color filter manufacturing method concerning the present invention includes: coat-forming, on a base, a layer of a color filter material including a dye; exposing, from above, a predetermined area on the layer; and forming a color filter on the predetermined area by removing an outside part of the predetermined area on the layer using a developer.

Using a dye including reaction radicals which have a photosensitive curing property makes it possible to let the dye accelerate the chain reaction in polymerization on sensing light resulting in curing the filter. This substantially eliminates the need to use a binder that is generally essential as a color filter material in the conventional technique, and thus it becomes possible to form color filters that are thinner by the thickness needed for a binder that becomes unnecessary. For example, it becomes possible to make color filters thinner to the degree of 0.8 μm or below.

Also, the image sensor concerning the present invention has the color filters.

In this way, it becomes possible to make the whole image sensor thinner, and thus it also becomes possible to make the sensitivity of the image sensor higher.

The color filter materials and the color filter manufacturing method concerning the present invention can make color filters thinner and realize thinner image sensors having a high sensitivity on which such color filters are mounted.

Further Information about Technical Background to this Application

The disclosure of Japanese Patent Application No. 2004-042589 filed on Feb. 19, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a cross section view of the unit pixel of an image sensor in a second embodiment of the present invention;

FIG. 2 is a diagram showing an arrangement example of color filters in the image sensor in the second embodiment of the present invention;

FIG. 3A to 3I are diagrams for describing the color filter manufacturing method in a third embodiment of the present invention; and

FIG. 4A to 4C are diagrams for describing the color filter manufacturing method in a fourth embodiment of the present invention.

### DESCRIPTION OF THE PREFERRED EMBODIMENT(S)

Embodiments of the present invention will be described with reference to figures.

### First Embodiment

Color filter materials concerning the present invention include a dye to which a light sensing function is added. Photosensitive curing reactions may be one of radical polymerization, cationic polymerization, and anionic polymerization.

Here are examples of available materials in an acrylic material in the case of using radical polymerization:
a compound obtained by adding acryloyl radicals to dye R: R—CO—CH═CH₂; and
a compound obtained by adding methacryloyl radicals to dye R: R—CO—C(CH₃)═CH₂.
   Another example of an available material in a nonacrylic material is an enethiol compound that is a compound having maleimide radicals.

When light is irradiated on the color filter materials including the dye to which a light sensing function is added in this way and a light curing initiator, the dye to which a light sensing function is added becomes a radical state resulting in accelerating a polymerization chain reaction. In other words, it becomes possible to obtain a polymer including a dye without using any binder.

In addition, here are examples of available materials in the case of using cationic polymerization: an epoxy compound; an oxetane compound; a vinyl ether compound; and a propenyl etherate.

Also, an epoxy compound can be listed as an example of an available material in the case of using anionic polymerization.

Further, color filter materials may have a dual curing property of light curing and heat curing. More specifically, on condition that a thermosetting material is included as a color filter material, when the temperature for heat curing is set at about 200° C., the thermosetting material cures resulting in further accelerating the curing reaction, which makes it possible to form a color filter.

As described above, the color filter material concerning the present invention includes a dye having photosensitive curing reaction radicals. Such photosensitive curing reaction radicals, on sensing light, accelerate a polymerization chain reaction resulting in curing. Therefore, with the color filter material, a binder that is essential as a color filter material in the conventional technique becomes virtually unnecessary, which makes it possible to form a color filter that is thinner by the thickness needed for a binder. More specifically, as the weight ratio of dye in the color filter material can be approximately 50% or more, the color filter can be made thinner to 0.8 μm or below.

As described earlier, in the conventional technique, increasing the amount of dye to obtain a sufficient spectral characteristic prevents dye from curing, and results in making a thick color filter. This causes a problem that an image sensor having such a filter becomes thicker. However, with the color filter material in the present invention, it becomes possible to manufacture a filter for green easily. In other words, a filter for green can be formed by using a single color layer without the needs to use two color layers. This makes it possible to make an image sensor thinner, and thus high sensitivity can be realized.

### Second Embodiment

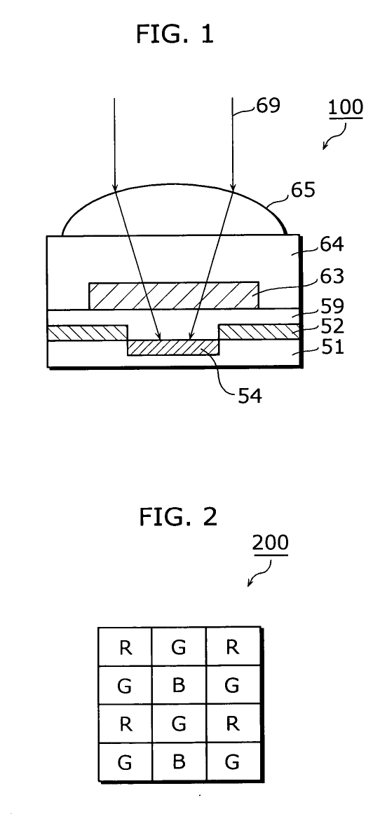

FIG. 1 is the section view of a unit pixel of an image sensor in a second embodiment of the present invention. As shown in FIG. 1, the unit pixel 100 includes a semiconductor substrate 51, a photodiode 54, a layer 52 that includes a light-shielding film, a wire and the like, a transparent film 59 for planalization, a color filter 63 in the present invention, a transparent planalization film 64, and an on-chip microlens 65 for collecting incident light.

As for an image sensor, on the semiconductor substrate 51 plural photo diodes 54 are formed at equal intervals in a matrix. The photo diodes 54 generates signal charge corresponding to the intensity of light that reaches the photo diodes 54 among incident light 69 that comes from above in FIG. 1. Also, the layer 52 including a light-shielding film, a wire and the like is formed in a way that it covers space between plural photodiodes 54. The layer 52 has openings above the photodiodes 54 in order to allow light to reach the photodiodes 54.

Also, above the openings of the layer 52 and photodiodes 54 the transparent film 59 is formed. The transparent film 59 has electrical insulating properties. For example, it is formed as a boron phosphorous silicon glass (BPSG) film that is formed using the chemical vapor deposition (CVD) method or a resin film that is formed by applying. On the area above the transparent film 59 and the openings the color filter 63 of the present invention is formed. The color filter 63 is formed in a matrix in an image sensor. For example, color filters for R, G and B are placed in a predetermined arrangement corresponding to photodiodes 54 respectively.

On the color filter 63 the transparent planalization film 64 is formed. On the transparent planalization film 64 on-chip microlenses 65 are formed in a matrix corresponding to photodiodes 54 respectively. The on-chip microlenses 65 collect light 69 that comes from above on the photodiodes 54.

It is desired that the transparent planalization film 64 be acrylic resin or the like that has a solvent resistance in order to prevent the color of the dye of the color filter 63 from becoming thinner in the later-described manufacturing process. Also, with a film that can block ultraviolet rays, it is possible to prevent ultraviolet rays from irradiating on and deteriorating the color filter 63.

FIG. 2 is a diagram showing an arrangement example of a color filter in an image sensor in the second embodiment of the present invention. As shown in the figure, in the image sensor 200, the green filter pattern shown as G is formed in checkers, and the red filter pattern shown as R and the blue filter pattern shown as B are alternately placed on the area where the green filter pattern is not formed.

Also, color filter layers made of cyan, yellow and magenta colors may be formed on the area for light receiving elements respectively in a predetermined arrangement instead of R, G and B colors. Note that the earlier-described light-shielding pattern is lattice-shaped, but it may be stripe-shaped.

In this way, with color filters in the present invention, it becomes possible to form thinner unit pixels and image sensors.

### Third Embodiment

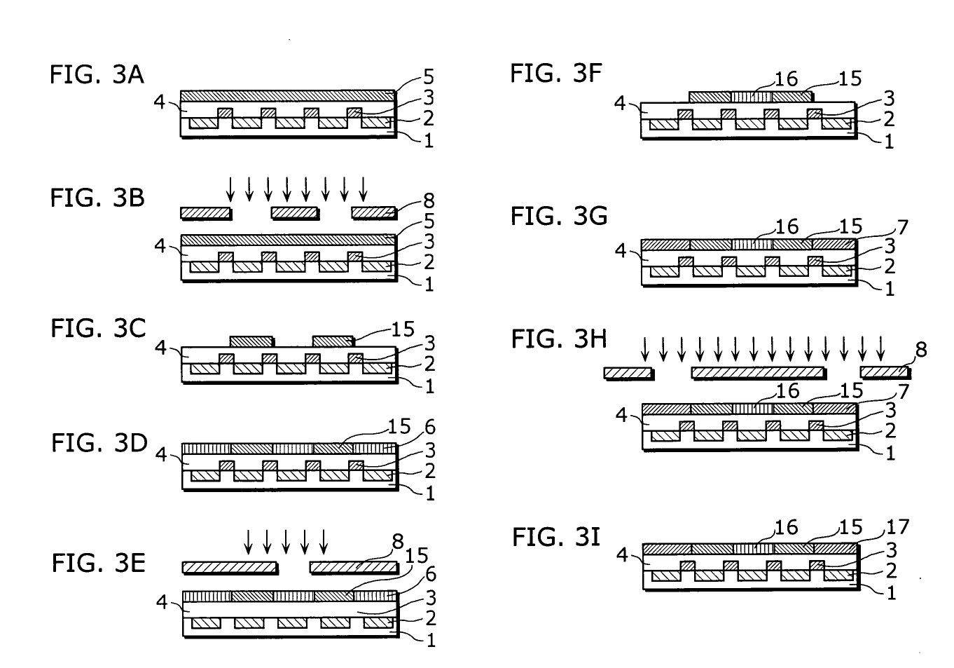

FIG. 3A to 3I are diagrams for describing the color filter manufacturing method in a third embodiment of the present invention. Here, the manufacturing method of three types (RGB) of color filters for image sensors will be described as an example.

As shown in FIG. 3A, the layer 3 including a wire and the like is formed on the semiconductor substrate 1 in which the light receiving parts (photodiodes) 2 are formed in a way that the layer 3 does not cover the openings of the light receiving parts 2. On the layer 3 the planarization layer (transparent film) 4 is formed. After that, on the planarization layer 4 a first color filter material 5 in the present invention is spin-coated. Next, as shown in FIG. 3B, a photomask 8 determining the area on which the first color filter is formed is set on it, and the pattern of a photomask is exposed by irradiating ultraviolet rays (i-line) from above. This cures only the first color filter material 5 in the predetermined area. Next, it is developed in an alkaline developer, the first color filter material 5 outside the predetermined area is removed by the alkaline developer, and the first color filter 15 is formed. In this way, as shown in FIG. 3C, the first color filter 15 is formed on the predetermined position.

Further, in order to form a second color filter that is different in type from the first color filter 15, the second color filter material 6 in the present invention is spin-coated on it as shown in FIG. 3D. Next, as shown in FIG. 3E, a photomask 8 determining the area on which the second color filter is formed is set on it, and the pattern of a photomask is exposed by irradiating ultraviolet rays from above. This cures only the second color filter material 6 in the predetermined area. Next, it is developed in an alkaline developer, the second color filter material 6 outside the predetermined area is removed by the alkaline developer, and the second color filter 16 is formed. In this way, as shown in FIG. 3F, the second color filter 16 is formed on the predetermined position.

Further in order to form a third color filter, as shown in FIG. 3G, the third color filter material 7 in the present invention is spin-sprayed on it. Next, as shown in FIG. 3H, the photomask 8 determining the area on which the third color filter is formed is set on it, and the pattern of a photomask is exposed by irradiating ultraviolet rays from above. This cures only the third color filter material 7 in the predetermined area. Next, it is developed in an alkaline developer, the third color filter material 7 outside the predetermined area is removed by the alkaline developer, and the third color filter 17 is formed. In this way, as shown in FIG. 3I, the third color filter 17 is formed on the predetermined position. After that a microlens is formed on the respective color filters 15 to 17, and an image sensor is completed.

Note that printing may be performed or a sheet may be used instead of spin coating.

In this way, with the color filter manufacturing system in the present invention, it is possible to manufacture thin color filters, and thus it becomes possible to form thinner image sensors.

### Fourth Embodiment

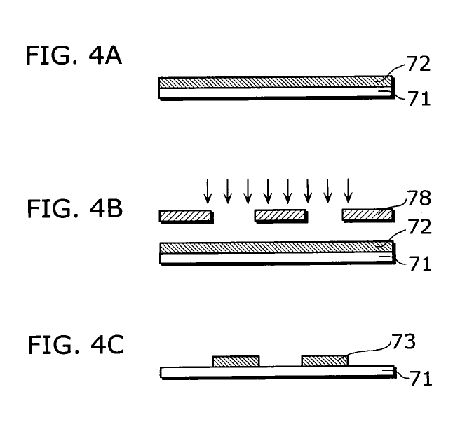

FIG. 4A to 4C are diagrams for describing the color filter manufacturing method in a fourth embodiment of the present invention. Here described a forming example of a glass substrate on which color filters are formed, such color filters being used for liquid crystals.

First, as shown in FIG. 4A, the color filter material 72 in the present invention is spin-sprayed on the glass substrate 71 that is the base. Next, as shown in FIG. 4B, a photomask 78 determining the area on which the color filter is formed is set on it, and the pattern of a photomask is exposed by irradiating ultraviolet rays from above. This cures only the color filter material 72 in the predetermined area. Next, it is developed in an alkaline developer, the color filter material 72 outside the predetermined area is removed by the alkaline developer, and the color filter 73 is formed in a predetermined position as shown in FIG. 4C.

Note that it is of course possible to form a color filter on the whole surface without setting a pattern like described above.

In this way, with the color filter manufacturing method in the present invention, it becomes possible to manufacture thin color filters used for liquid crystals.

The descriptions up to this point have been made based on embodiments in the present invention, but application examples are not limited to those embodiments.

For example, as described above, a resin, a solvent, a thermosetting material, a light curing initiator, a filler, an additive may be added when forming a color filter material with a view to improve the properties of the materials in the color filter forming process and the curing property of the color filters.

Also, as for ultraviolet rays used in the exposure process, i-line, g-line h-line or a mixture of such lines may be used. Also, it may be ultraviolet rays or electron rays having another wavelength. Further, dyes for use may be complementary colors or primary colors.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The color film materials, color filters and their manufacturing methods in the present invention are applicable for color filters that are mounted on CCDs, MOS sensors and the like. Further, they are applicable for image sensors that are mounted on the digital video cameras, digital still cameras, mobile phones with a camera and the like, and color filters used for liquid crystals. Therefore, they are industrially useful.

1. A color filter material comprising a dye which has a light sensing function.

2. The color filter material according to claim 1,
wherein said dye cures upon sensing light by one of radical polymerization, cationic polymerization and anionic polymerization.

3. The color filter material according to claim 2,
wherein said dye includes a compound having acryloyl radicals and radically polymerizes upon sensing light.

4. The color filter material according to claim 2,
wherein said dye includes a compound having methacryloyl radicals and radically polymerizes upon sensing light.

5. The color filter material according to claim 2,
wherein said dye includes at least one of a compound having maleimide radicals and an enthiol compound, and radically polymerizes upon sensing light.

6. The color filter material according to claim 2,
wherein said dye includes at least one of an epoxy compound, an oxetane compound, a vinyl ether compound and a propenyl etherate, and cationically polymerizes upon sensing light.

7. The color filter material according to claim 2,
wherein said dye includes an epoxy compound and anionically polymerizes upon sensing light.

8. The color filter material according to claim 1,
wherein said dye further has a heat curing property.

9. A color filter comprising a color filter material including a dye which has a light sensing function.

10. An image sensor comprising a color filter made of a color filter material including a dye which has a light sensing function.

11. A color filter manufacturing method comprising:
coat-forming, on a base, a layer of a color filter material including a dye which has a light sensing function;
exposing, from above, a predetermined area on the layer; and
forming a color filter on the predetermined area by removing an outside part of the predetermined area on the layer using a developer.
